(19) United States
(12) Patent Application Publication
(10) Pub. No.: US 2007/0227134 A1
(43) Pub. Date: Oct. 4, 2007

(54) Hydraulically powered engine

(76) Inventor: Danny R. Lambert, Poteau, OK (US)

Correspondence Address: Danny R. Lambert, P.O. B. 363, Poteau, OK, 74953, US

(21) Appl. No.: 11/391,598

(22) Filed: Mar. 28, 2006

(51) Int. Cl. F16D 31/02

(52) U.S. Cl. 60/419

(57) ABSTRACT

An improved hydraulically powered engine that is of basic design, has battery 24 and DC motor 10 coupled to a hydraulic pump 14A for starting engine. Once RPMs are reached, starter switch 22 will be returned to run position, DC motor 10 will disconnect. Motor at set RPMs will use main pump 14B to maintain fluid power supply. Throttle valve 18 will control fluid volume to regulate RPMs. Engine has charging device 34 to maintain battery 24 supply for starting procedures. Also, engine has electrical disconnect valve 40 which opens as starter switch 22 is turned to on position, and disconnect valve 40 closes when starter switch 22 is turned to off position, to shut down engine. Hydraulic power source uses twisting force for engines rotation, and torque arm 12 magnifies twisting force for greater horsepower.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The invention is in the field of hydraulic engines, but of an improved basic design that is simple and easy to maintain and operate.

2. Prior Art

Before this engine several inventors invented different types of engines. For example, U.S. Pat. No. 3,948,047 to Gilbert (1976) discloses an engine that is powered by an electric or gasoline motor, as its main power source; however, this engine had to use a flywheel and was intended for light duty vehicles, such as golf carts. Also, this invention has not found great acceptance in the vehicle field.

Another example of a hydraulically operated engine is U.S. Pat. No. 4,413,698 to Conrad et al. (1983) which was a battery hydraulically operated engine that was used to drive a light weight utility vehicle; however, this engine was very costly to maintain. Manufacturers recommended batteries be recharged after 20% of loss. Invention did prolong use between batteries being charged, but the disadvantage of the engines main power source was expensive batteries and the need to be recharged. Also, another disadvantage was the engine contained too many expensive components.

This is of simple design, anyone with basic knowledge of starting and operating a fossil fuel or natural gas engine, can operate this invention easily. Anyone who has basic mechanical skills can maintain repairs of this engine with ease.

### BACKGROUND OF INVENTION—OBJECTS AND ADVANTAGES

Several objects and advantages of this present invention are:
(a) system is of simple design and can be operated with no special training;
(b) can eliminate the need and use of foreign fuels for the safety of the economic future.
(c) this technology will produce jobs for economic growth by having a resource that is reusable instead of purchasing foreign fuels;
(d) there are no air pollutants that are harmful to the environment,
(e) there is no need for several costly batteries, and the engine can be used in both lightweight and heavy duty applications.

Furthermore, this invention allows for both economical growth and no dependents on foreign fuels, which allows the consumer more freedom to travel at less cost as well as the convenience of being able to operate the engine with no special training. The maintenance is basic mechanical means. The immediate advantage achieved will be the elimination of smoke and all other pollutants, into the atmosphere and water.

### SUMMARY

In accordance to prior inventions, this is a hydraulically operated engine with a simple design and competitive cost to engines built today with the advantage of a renewable source, instead of costly fuels. This engine can be repaired and maintained with common basic mechanical skills.

### DRAWINGS—FIGURES

FIG. 1 illustrates a block diagram of a perspective view of my invention.

FIG. 2 illustrates a block diagram of a battery powered motor manually coupled to hydraulic pump. Also, this is illustrated in FIG. 1.

FIG. 3 illustrates a block diagram utilizing a mechanical combination with a hydraulic motor drive coupled to a torque arm.

FIG. 4 illustrates a block diagram if oil type bearings are used, a housing will be used to contain oil for bearings and gears.

Drawings - - Reference Numerals

| | |
|---|---|
| 10) | DC Motor |
| 12) | Torque Arm |
| 14A) | Hydraulic Pump |
| 14B) | Hydraulic Pump (main) |
| 16) | Relief Pressure Valve |
| 18) | Throttle Valve |
| 20) | Solenoid |
| 22) | Starter Switch |
| 24) | 12 volt battery |
| 26) | Hydraulic Motor |
| 28) | Oil Seals (optional) |
| 30A) | Barring |
| 30B) | Main Barring |
| 30C) | Barring |
| 30D) | Barring |
| 32A) | Main Thrust Gear |
| 32B) | Power Gear |
| 34) | Charging Device |
| 36) | Main Thrust Shaft |
| 38) | Hydraulic Tank |
| 40) | Disconnect Valve |
| 42) | Power Supply Shaft |
| 44A) | Check Valve |
| 44B) | Check Valve |
| 46) | Fluid Conduit |
| 48) | Fluid Conduit Tee |
| 50A) | Mechanical Coupler |
| 50B) | Mechanical Coupler |
| 50C) | Mechanical Coupler |
| 52) | Torque Plate |
| 54) | Electrical Conduit |
| 56) | Gear and Bearing Oil Housing (optional) |

In addition bearings (30A-30D) can be oil type or grease type.

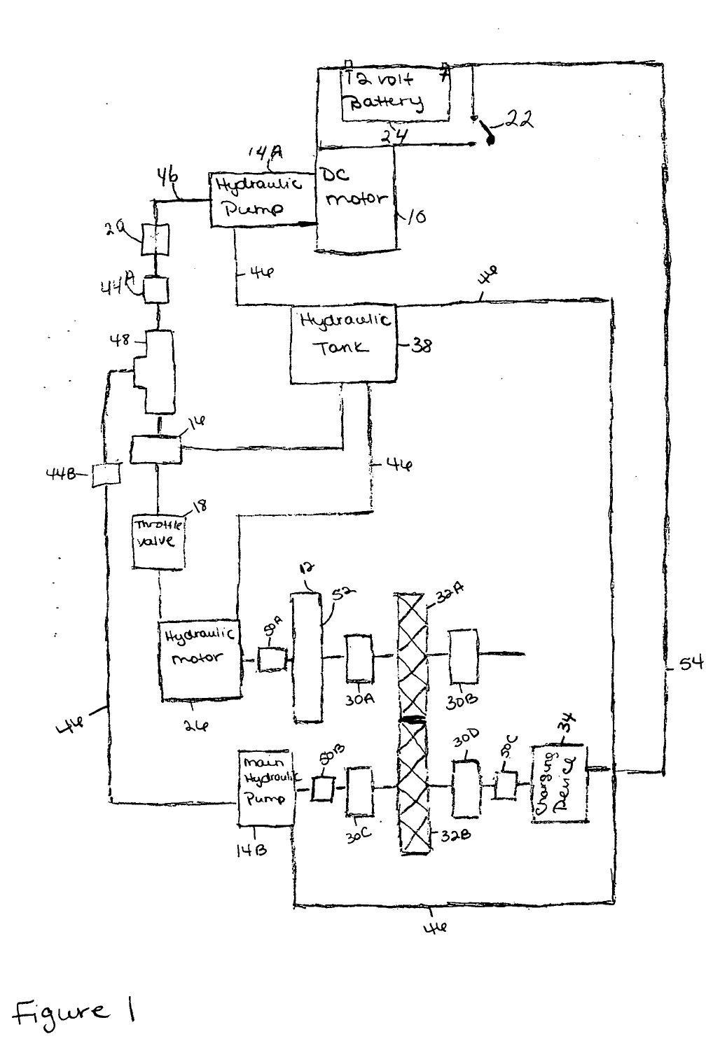

### DRAWING DESCRIPTION—FIG. 1—PREFERRED EMBODIMENT

The present invention is more fully illustrated in connection with FIG. 1, which shows a block diagram for a hydraulically powered engine. The engine described in connection with FIGS. 1, 2, and 3, comprises of a DC motor 10, that is coupled to a fluid pump 14A.

DC motor 10 is connected through operating terminals to the 12 volt battery 24, which is then connected through operating terminals, starting switch 22. There is a fluid conduit 46 connected between hydraulic pump 14A and the check valve 44A, hydraulic pump 14A also has fluid conduit line 46 for suction from hydraulic tank 38.Check valve 44A has fluid conduit 46 that is connected to the fluid conduit Tee 48 then through fluid conduit 46 to relief pressure valve 16. When pressure relief valve 16 is activated there is a fluid conduit 46 to put relief pressure back into hydraulic tank 38.

Relief valve 16 has fluid conduit 46 connecting to throttle valve 18 which has fluid conduit 46 connecting to hydraulic motor 26. Hydraulic motor 26 has fluid conduit 46 to return hydraulic fluid back to hydraulic tank 38.

Hydraulic motor 26 has a mechanical coupler 50A that is connected to torque arm 12, torque arm 12 is coupled to torque plate 52. Torque plate 52 is coupled to main thrust shaft 36, then shaft 36 proceeds through bearing 30A, then shaft 36 proceeds through main thrust gear 32A then shaft 36 proceeds through bearing 30B. Then shaft 36 proceeds out and can be coupled with a mechanical coupler of users choice.

Main thrust gear 32A is meshed against power gear 32B which has power shaft 42 running through the center of the power gear 32B, then power shaft 42 on one side of power gear 32B runs through bearing 30D. Then power shaft 42 has a mechanical coupler 50C connected to charging device 34, charging device 34 has electrical conduit 54 connecting to 12 volt battery 24.

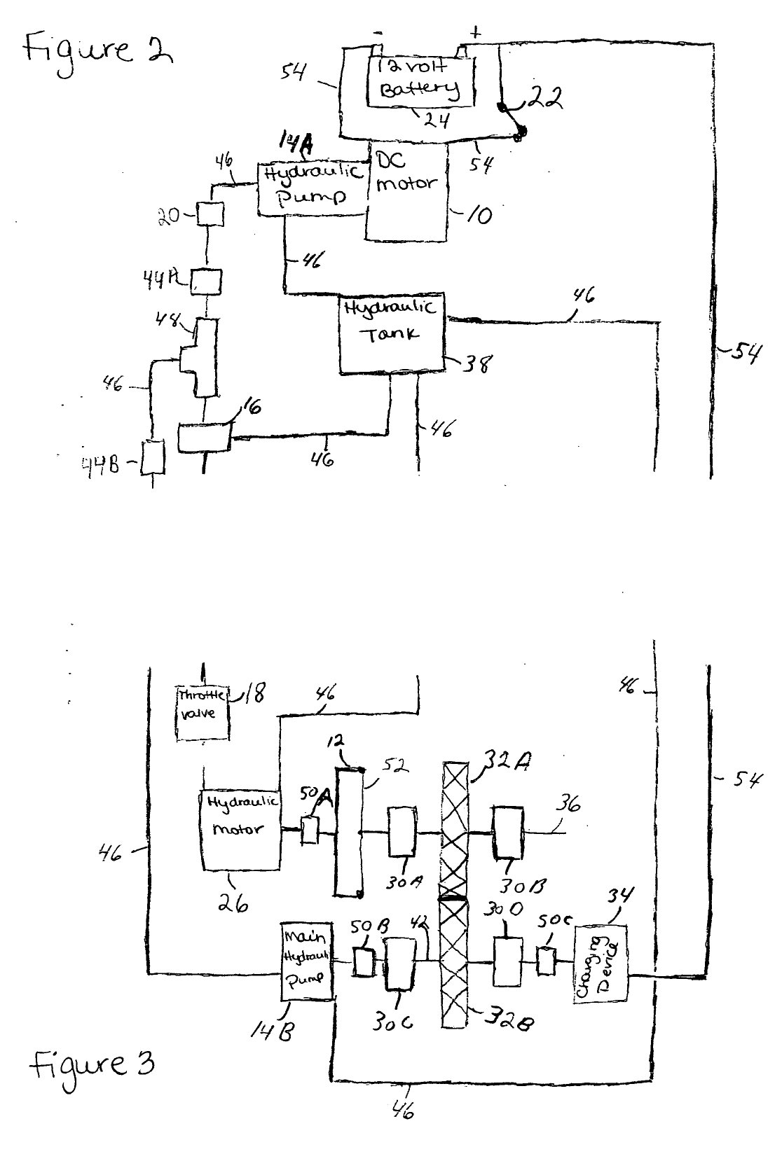

Shaft 42 coming out of power gear 32B is running in opposite direction runs through bearing 32C then shaft 42, then has a mechanical coupler 50B to hydraulic pump 14B. Hydraulic pump 14B has one fluid conduit 46 running to hydraulic tank 38 for suction line and one fluid conduit 46 running to check valve 44B, and then fluid conduit line 46 running to fluid conduit tee 48 as seen in FIG. 2, to provide main fluid power for engine.

If oil type bearings are used, an oil containment housing will use oil seals 28 to seal around the main thrust shaft 36, and oil seals 28 will be used around power supply shaft 42 to contain gear oil.

Operation

In FIG. 2, a conventional 12 volt battery 24 is located on the engine and provides a source of power for operating a starter switch 22, which is associated with a solenoid 20. Starter switch 22 when turned to start position provides a source of power to DC motor 10, which is coupled to the fluid pump 14A.

By turning starter switch 22 to start position, you are able to use power source of 12 volt battery 24 to activate DC motor 10 to pump fluid, to provide fluid power through conduit to power hydraulic motor 26. Also, from the starter switch 22 through operating terminals there is a disconnect valve 40 which opens after switch 22 is activated that lets fluid pass through fluid conduit. When starter switch 22 is turned to off position, disconnect valve 40 will close and shut engine down.

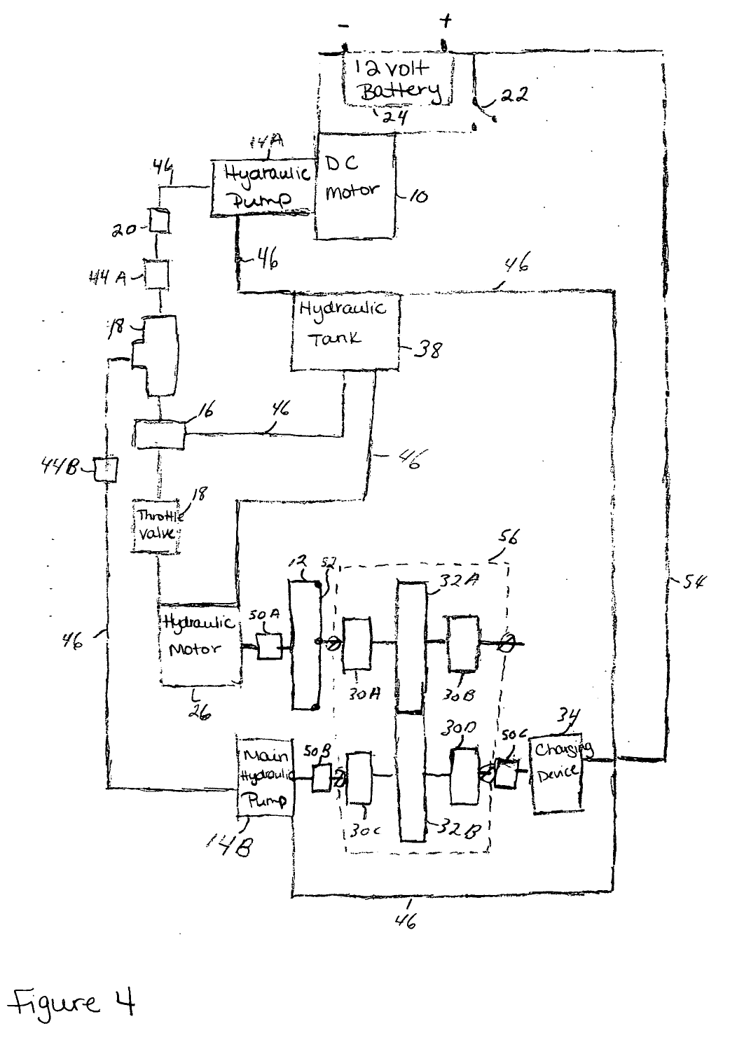

Demonstrated in FIG. 3, as previously shown in FIG. 2, fluid power has been provided through a conduit to allow a hydraulic motor 26 to rotate, hydraulic motor 26 which is mechanically coupled to main torque arm 12 which is then mechanically coupled to torque plate 52, which is attached to main thrust shaft 36 which allows the rotation by use of bearings 30A and 30B which in the middle of the shaft, is main power gear 32B which is half way between bearings 30A and 30B, which rotates against main thrust gear 32A which has two bearings 30C and 30D which allows shaft 42 to remain in place and rotate.

Shaft 42 is connected, one end is mechanically coupled to a charging device 34 and on the opposite end it is mechanically connected to a fluid pump 14B. Fluid pump 14B is main fluid power for engine operation. As seen in, FIG. 2, fluid power is provided through fluid conduit and both FIGS. 2 and 3 are connected at fluid conduit T which has a check valve 44A and 44B which prevents back pressure from running to fluid pump 14A or 14B. Also, connected to fluid conduit is relief valve 16 which prevents excessive pressure build up, fluid goes through conduit, through disconnect valve 40, to throttle valve 18. Throttle valve 18 is what controls RPMs by controlling fluid speed to hydraulic motor 26.

Relief valve 16 is connected through fluid conduit to fluid tank 38. Fluid tank 38 is connected through conduit to fluid pump 14A and 14B. The basic math that describes how this engine works is this, Horsepower=torque (ft. lbs.)×RPM divided by 5252.

Conclusions, Ramifications, and Scope

Accordingly, the reader will see that this engine is of basic simple design. Anyone with the knowledge to operate a standard fossil fuel or natural gas engine would have the knowledge to operate this engine. In addition, this engine has a reusable fuel supply, and no burning of fossil fuels of any type is needed. This helps with environmental problems. Furthermore, other advantages include: less likely of hazardous explosives from combustible fossil or natural gas fuels.

Although, the description above contains many specifics, these should not be construed as limiting the scope of the invention but as merely providing illustrations of some of the presently preferred embodiments of this invention. For example, this engine can be built out of several different materials, such as metal, aluminum, etc., also fluid can be of oil, water, etc., and can be produced in different shapes and sizes to accommodate large and small applications of use.

Thus the scope of this invention should be determined by the appended claims and their legal equivalents, rather than be limited to the examples given.

I claim:

1. An engine that uses hydraulic power source.

2. As seen in claim 1, an engine that uses a hydraulic power that produces rotational power,

3. As described in claim 2, a hydraulic power source that is connected to a torque multiplier to magnify twisting force on main shaft.
